(19) United States
(12) Patent Application Publication
(10) Pub. No.: US 2007/0216907 A1
(43) Pub. Date: Sep. 20, 2007

(54) JEWELRY INNER STRUCTURE DETECTING METHOD AND APPARATUS THEREOF

(76) Inventors: Hui Wang, Shenzhen (CN); Yonghong He, Shenzhen (CN); Hui Ma, Huizhou (CN)

Correspondence Address: KING & SCHICKLI, PLLC, 247 NORTH BROADWAY, LEXINGTON, KY, 40507, US

(21) Appl. No.: 11/619,217

(22) Filed: Jan. 3, 2007

(30) Foreign Application Priority Data
Mar. 14, 2006 (CN) 200610057546.6

(51) Int. Cl. G01B 9/02

(52) U.S. Cl. 356/479

(57) ABSTRACT

A method for the jewelry inner structure detection comprising steps of dividing the light emitted from a low coherence light source into two beams by means of a light splitter, one beams is then directed to a sample arm on which a gem to be detected is fixed and the other beam is directed to a reference arm capable of cause optical path length change and reflect light; adjusting the optical path length; transforming the light interference signal into a corresponding electrical signal; and transferring the electrical signal to a signal processor and analyzer; changing the optical path of the reference arm, obtaining one dimensional light intensity signal in the gem depth direction and then lateral scanning the gem to be detected to obtain a two dimensional optical slice image of the gem.

### BACKGROUND OF THE INVENTION

1. Technical Field

The present invention relates to a method for jewelry inner structure detection, and more particularly, to method for non-contact, non-destructive jewelry inner structure detection and the apparatus thereof.

2. Description of the Prior Art

The means for detecting jewelries inner structure, particularly for optical scattering or translucent jewelries' inner structure is always an imperative question. In the prior art, common methods for detecting jewelries inner structure can be divided into two categories: indirect detection methods which are delegated by X-ray imaging method and comparison method, and direct measurement exemplified by sample slice arbitration.

Take the measurement of the nacre coating thickness of a cultured pearl for instance; traditional detection methods mainly include the followings:

1. Comparison method. The principle is that: preparing a set of standard samples whose nacrous thickness has been decided, illuminating the sample by strong light, comparing the samples to be detected with the standard samples under gem microscope, and deciding the thickness grade of the sample to be detected.

2. X-ray photographic method. The principle is that: preparing a set of standard samples whose nacrous thickness has been decided, putting both the sample to be detected and the standard sample on the photograph table of an X-ray camera, taking X-ray perspective picture, comparing and deciding the pearl layer thickness on the picture, and

3. Direct destructive detection method. The principle is that: split the sample to be detected from the center and rubdown the sample, measure the nacre layer thickness at several different positions with a measure microscope, obtain a mean value, and determine the thickness of the pearl.

In the aforesaid technologies, method 1 belongs to indirect measurement method upon which the exact value of the nacreous thickness of the pearl can not be obtained. Method 2 could only be performed in special laboratories, which is inconvenient and even impossible in many business situations. And method 3 belongs to destructive measurement, in which the sample must be destructed.

Therefore, it is expected in the art that a non contact direct detection method, which does not demolish the jewelry, is proposed.

### SUMMARY OF THE INVENTION

An object of the present invention is to provide a method for detecting the inner structure of jewelry based on optical interference, photoelectric conversion and scanning technologies.

This object is achieved by providing a method includes following steps:
a. dividing the light emitted from a low coherence light source into two beams by means of a light splitter, one beams is directed to a sample arm on which a gem to be detected is fixed and the other beam is directed to a reference arm capable of cause optical path length change and reflect light;
b. adjusting the optical path length, to make said reflect light from the reference arm interfere with the light reflected from the gem to be detected;
c. transforming the light interference signal into a corresponding electrical signal; and transferring the electrical signal to a signal processor and analyzer; changing the optical path of the reference arm, obtaining one dimensional light intensity signal in the gem depth direction;
d. lateral scanning the gem to be detected to obtain a two dimensional optical slice image of the gem.

The present invention makes the back scattered light interference with the reference light based on the optical interference principle, and then detects the interference signal to determine the jewelry inner structure. In the meantime, the present invention obtains the intuitionistic inner structure image by scanning.

Other than destroy the gem to see the inner structure, the method of the present invention obtains an inner image of the gem optically, which makes it a non contact, non destructive and high resolution method.

Another object of the present invention is to provide an apparatus for detecting the inner structure of jewelry based on optical interference, photoelectric conversion and scanning technologies.

This object of the invention is achieved by providing an apparatus comprising:
a light source set,
an optical splitter,
a reference arm reflector,
a photoelectronic detector,
a signal processor and analyzer,
a reference arm reflector scanning means, and
a sample arm scanning means;
the light source set are optically connected to the input end of the optical splitter, the two outputs of the optical splitter are optically connected to the reference arm reflector and the gem to be detected respectively, the interference light output end of the optical splitter are optically connected to the photoelectronic detector; the output end of the photoelectronic detector is connected to the electrical signal processor and analyzer.

Preferably, the light source is a low time coherence light source having a coherence length of 0.5 μm to 1 cm. e.g. a Super Luminescent Diode (SLD), a LED, a infrared light source or a visible light source. Optical path change and modulation resulted from scanning of the reflector of the reference arm can be achieved by driven a motorized translation stage, or by the use of optical scanner.

Back scattered light inside a gem is very weak, the present invention makes the weak scattered light interference with the relatively stronger reference light based on the optical interference principle, and detects the interference signal to determine the jewelry inner structure, which leads to high detection sensitivity and high Signal-to-Noise ratio.

Optical fiber interference technology is used in the present invention as a result of which excellent flexibility, portability and external interference (e.g. ambient light, EMI) resistance is achieved which make the present invention being readily implemented on site.

### BRIEF DESCRIPTION OF THE DRAWINGS

FIG. 1 depicts an illustrative diagram of the present invention;

FIG. 2 depicts an illustrative view of one embodiment of the detection apparatus of the present invention;

FIG. 3 is an illustrative block diagram of a signal processor and analyzer in the embodiment of FIG. 2;

FIG. 4 is a pearl layer image obtained from the embodiment of FIG. 2.

### DESCRIPTION OF THE PREFERRED EMBODIMENTS

The present invention will be further illustrated from the following description with reference to the drawings.

The method for detecting the inner structure of jewelry of the present invention is implemented according to the following steps:

Prepare an optical Michelson interferometer. The light emitted from a light source is split into a reference arm light beam and a sample arm light beam, wherein the reference arm light beam is directed to a reflect mirror and the sample arm light beam is directed to the gem to be detected. When the scanning of the reference arm starts, the optical path was changed and modulated continuously, result in the back scattered light from different depth of the gem superpose and interference with the reflect light from the reference arm at the light splitter, whereby a interference light signal is generated. The interference light signal is then received by a photoelectronic detector, where it is transformed into an interference light electric signal. The interference light electric signal is received by a signal processor and analyzer, and is amplified and processed thereafter. After processing, one dimensional reflective light intensity signal in the inward depth direction of the gem can be obtained, and hence, the inner structure of the gem. Two dimensional optical slicing visual image of the inner structure of the gem can be obtained by scanning the gem to be detected by means of light beam of sample arm,

The detection apparatus for the jewelry inner structure of the present invention is implemented by means of the following embodiments:

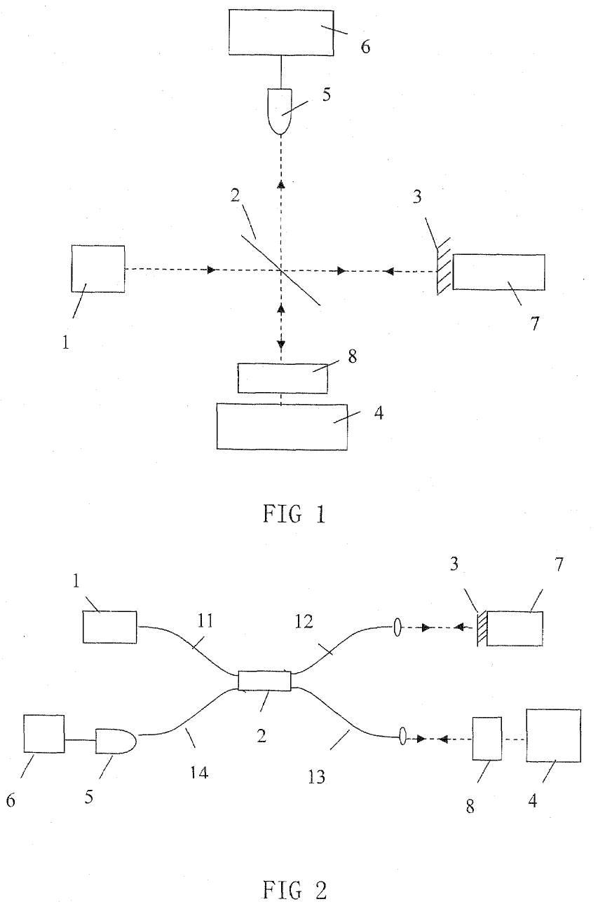

As it is shown in FIG. 1, the apparatus for the jewelry inner structure detection comprising: a light source 1, an optical splitter 2, a reference arm reflector 3, a photoelectronic detector 5, a signal processor and analyzer 6, a reference arm reflector scanning means 7 and sample arm scanning means 8, wherein the light source set 1 is optically connected to the input end of the optical splitter 2, the two outputs of the optical splitter 2 are optically connected to the reference arm reflector 3 and the pearl 4 to be detected respectively, the interference light output end of the optical splitter 2 is optically connected to the photoelectronic detector 5. The output end of the photoelectronic detector 5 is electrically connected to the electrical signal processor and analyzer 6.

In the embodiment, the light source 1 may be a low time interference light source, the coherence length of the light source may between 0.5 μm and 1 cm. The light source 1 includes a light emitting component and a driver circuit thereof, the light emitting component is a Super Luminescent Diode (SLD), or a LED, or an infrared luminotron.

The optical splitter 2 can be a prism-type beam splitter, or a mirror-type beam splitter, or an optical fiber coupler.

In the embodiment of FIG. 2, the light source 1 includes a light emitting component and a driver circuit thereof; the light emitting component may be an optical fiber coupled Super Luminescent Diode having a center wavelength of 1310 nm and a power of 5 milliwatt. The light source driver circuit may be a common constant current source driver formed by an auto current control (ACC) circuit. The light splitter 2 may be an optical fiber coupler having two outputs and two inputs, and having a splitting ratio of 50%:50%, the collimator by use of which the optical fiber coupler is connected to the optical fiber 12 and 13 may be gradient index lens. Two beams of light collimated from the outputs of the optical fiber coupler are directed to the reference arm reflector 3 and the gem to be detected 4 through optical fiber 12 and 13 respectively. The reflect light from the reference arm reflector 3 and the back scattered light from the gem to be detected return to the optical fiber coupler through optical fibers 12 and 13 respectively. The interference light output of the optical fiber coupler is connected to the photoelectronic detector 5 through an optical fiber 14. The output end of the photoelectronic detector 5 is electrically connected to the electronic signal processor and analyzer 6.

The photoelectronic detector 5 can be an InGaAs photodiode with pre-amplifier, an avalanche diode or a CCD device.

The reference arm reflector 3 comprises a gold coated mirror. The mirror is mounted on a reference arm reflector scanning means 7 capable of move reciprocatively. The reciprocating frequency of the reference arm reflector may be several Hz to hundreds Hz. The scanning means 7 of the reference arm reflector can be driver by a piezoelectric ceramics set, a motorized translation stage, a vibrating motor, a linear motor or a voice coil motor. In the current embodiment, the reference arm reflector is driven by a motorized translation stage to change the optical path length of the reference light

The light beam scanning device 8 of the sample arm can be an optical scanner or a motorized translation stage. In this embodiment it is an optical scanner.

Light with a stable intensity is generated by the light source 1, which is then coupled into one input end of the optical fiber coupler (such as an optical fiber coupler with two output ends and two input ends) and is split by the optical fiber coupler according to a specific light splitting ratio (such as 50%:50%), and then emitted from two output ends of the optical fiber coupler. After collimation, one beam of light is directed to the vibrating reference reflector, another beam of light is directed to the gem to be detected. The back scattered light from the gem to be detected meets the reflect light from the vibrating reference reflector at the optical fiber coupler, and interferences occurs.

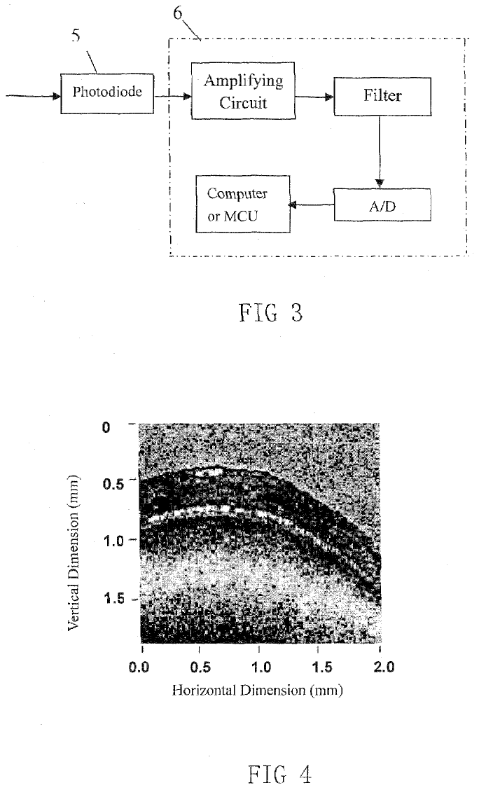

As it is shown in FIG. 3, the signal processor and analyzer 6 comprises an amplifying circuit, a filter, an analog to digital converter (A/D) and a computer. The filter is connected to the output end of the amplifying circuit, the output end of the filter circuit is connected to the input end of the analog to digital converter, and the digital output end of the analog to digital converter is connected to the input of the computer. The amplifying circuit may be an OP27 operational amplifier from Burr-Brown Company, the filter circuit may be a YE3790A band-pass filter from JIANGSU LIANNENG CO. LTD, China, and the analog to digital converter may be a PCI-611 type analog to digital acquisition card from NI Company. The signal processor and analyzer 6 could also comprise a single-chip computer, an amplifying circuit, a filter circuit and an analog to digital conversion circuit.

With corporation of the detection apparatus shown in FIG. 2, take the pearl layer thickness detection method for instance, to method for the detection of jewelry inner structure will be further illustrated here.

Light with a stable intensity which is emitted from a Super Luminescent Diode light source 1 is coupled into the optical fiber coupler 2 having two inputs and two outputs.

The light with a stable intensity is split into two beams by the optical fiber coupler 2. One beam of light is directed to the reference arm reflector 3 through optical fiber 12, and the other is directed to the pearl to be detected 4 through optical fiber 13. The back scattered light from the pearl to be detected 4 meets the reflected light from the reference arm reflector 3 at the optical fiber coupler 2, and interferences occurs. The obtained interference light signal is then coupled into the photoelectronic detector 5 through optical fiber 14.

The interference light signal received by the photoelectronic detector 5 is then transformed into an electrical signal which is then sent to the signal processor and analyzer 6.

In the signal processor and analyzer 6, the interference photoelectronic signal is amplified, filtered and digitized, and the result is then analyzed by the computer. Whereby one dimensional inward depth light intensity signal and consequently the pearl layer thickness value is obtained. Two dimensional image of the pearl layer as shown in FIG. 4, from which the pearl layer thickness may be measured directly, can be obtained by scanning the pearl by the light beam scanning means 8 of the sample arm.

1. A method for the jewelry inner structure detection comprising steps:
a. dividing the light emitted from a low coherence light source into two beams by means of a light splitter, one beams is then directed to a sample arm on which a gem to be detected is fixed and the other beam is directed to a reference arm capable of cause optical path length change and reflect light;
b. adjusting the optical path length, making the reflect light from the reference arm interfere with the light reflected from the gem to be detected on the sample arm;
c. transforming the light interference signal into a corresponding electrical signal; and transferring the electrical signal to a signal processor and analyzer; changing the optical path of the reference arm, obtaining one dimensional light intensity signal in the gem depth direction;
d. lateral scanning the gem to be detected to obtain a two dimensional optical slice image of the gem.

2. A method for the jewelry inner structure detection according to claim 1, wherein the light source is a low time interference light source, the coherence length is between 0.5 μm and 1 cm.

3. A method for the jewelry inner structure detection according to claim 1, wherein detecting the intensity signal of the reflect light in the inner of the gem sample to be detected by optical interference principle.

4. A method for the jewelry inner structure detection according to claim 1, wherein the optical interference signal is transformed into a corresponding electronic signal by a photoelectronic detector.

5. An apparatus for the jewelry inner structure detection characterized in that it comprising:
a light source,
an optical splitter,
a reference arm reflector,
a photoelectronic detector,
a signal processor and analyzer,
a reference arm reflector scanning means, and
a sample arm scanning means;
the light source set are optically connected to the input end of the optical splitter, the two outputs of the optical splitter are optically connected to the reference arm reflector and the gem to be detected respectively, the interference light output end of the optical splitter are optically connected to the photoelectronic detector; the output end of the photoelectronic detector is connected to the electrical signal processor and analyzer.

6. An apparatus for the jewelry inner structure detection according to claim 5, wherein the light source includes a light emitting component and a driver circuit thereof, the light emitting component is a Super Luminescent Diode, a LED, or an infrared luminotron.

7. An apparatus for the jewelry inner structure detection according to claim 5, wherein the optical splitter is a prism-type beam splitter, a mirror-type beam splitter, or an optical fiber coupler.

8. An apparatus for the jewelry inner structure detection according to claim 5, wherein the photoelectronic detector is a photodiode, an avalanche diode or a CCD device.

9. An apparatus for the jewelry inner structure detection according to claim 5, wherein all parts are connected by optical fiber to conduct and detect light.
